(19) United States
(12) Patent Application Publication
(10) Pub. No.: US 2002/0009296 A1
(43) Pub. Date: Jan. 24, 2002

(54) Transceiver units and a transceiver system for the remote control of electronic equipment

(75) Inventors: Richard Shaper, Old Brookville, NY (US); Henry Gong, Garden City, NY (US)

Correspondence Address: CURTIS MALLET-PREVOST COLT & MOSLE,LLP, 101 PARK AVENUE, 35TH FLOOR, NEW YORK, NY, 10178, US

(73) Assignee: Quantum Instruments, Inc., Garden City, NY

(21) Appl. No.: 09/899,953

(22) Filed: Jul. 6, 2001

Related U.S. Application Data
(60) Provisional application No. 60/220,041, filed on Jul. 21, 2000.

(51) Int. Cl. G03B 15/03; G03B 17/00

(52) U.S. Cl. 396/56; 396/182

(57) ABSTRACT

The present invention is a transceiver and system for controlling photographic equipment. Each transceiver unit of the present invention can be pre-set as an “originating,” “remote” or “relay” unit, and regardless of which setting, each unit is capable of transmitting and receiving coded radio or optical signals. Each unit has at least one selector switch, various input and output connections, a transceiver chip, a microcontroller and associated electronic circuits. Encoded signal pulses containing channel, system, and control codes are transmitted, received and/or relayed between units. The ability to select the function of any one transceiver allows identical units to be flexibly employed as a system and readily configured by the user.

### BACKGROUND OF THE INVENTION

The present invention involves wireless remote control for photographic equipment, specifically wireless remote controls for cameras and electronic flash apparatus.

### DESCRIPTION OF THE PRIOR ART

Photographers often require wireless remote control of their cameras, photo flash lighting, or other photographic equipment. In some situations, photographers cannot be close enough to the subject matter in order to operate their equipment. In other situations, artificial lighting apparatus, such as photographic flash units, needs to be controlled remotely but in synchronous operation with a camera and/or other photographic flash units. It is often a requirement for photographic flash equipment to flash synchronously with the opening of the camera shutter to achieve the desired lighting exposure. In another application of such wireless control devices a camera shutter may be activated by the photographer from a remote location.

Photographic flash units have been triggered by an electrical or optical signal generated by the camera, synchronous with the shutter opening. Such flash units are connected to the camera by a wired cable. More recently, wireless means of triggering the flash apparatus has been provided by radio signals, or infrared or visible light pulses. In such arrangements, a transmitter is connected to and activated by the shutter synchronization signal from a camera. The transmitter sends a signal to a receiver which is connected to the remote flash apparatus, and which triggers the operation of the flash apparatus synchronized with the shutter release.

There are two significant requirements for effective wireless remote control of photographic equipment: signal transmission speed and signal reliability. The wireless signals need to be fast enough to achieve proper synchronization with the camera shutter, which may be open for as little as 1/1000 of a second.

In order to achieve reliable wireless flash synchronization, various coding techniques have been used. Coding prevents false triggering and filters out noise. The coding techniques used have to be fast enough to minimize timing errors or delays. Existing devices use common binary codes of the types used in such devices as television and home entertainment electronics remotes, garage door openers and the like. The coding often includes a “system” code so that transmitters and receivers coded in one system do not interfere with those coded to a different system. The code may also include a “channel” code to activate different receivers coded to the same system.

Code detection in prior art systems has been accomplished by various means including tuned circuits, digital discriminators, discrete digital logic and by microprocessor control.

Prior art in wireless flash and camera control are limited in several ways. All wireless transmission of coded signals can become corrupted or interfered with from time to time, due to natural and man-made interference or operational errors. Users of such systems desire the ability to determine and fix the causes of flash or camera misfirings.

There is also the problem of the versatility of the control devices used in prior art systems. Previously, a user would own a combination of receivers and transmitters for remote control. Sometimes one transmitter would be used to control three receivers, for example. At other times, a photographer will need two transmitters and two receivers and will have to buy additional units. The present invention implements transceivers that can be used as receivers or transmitters.

There is an additional problem of the limited range of remote control devices which are subject to radio power emission limits by government regulations, such as those promulgated by the Federal Communication Commission, as well as other natural and man-made factors.

### SUMMARY OF INVENTION

The present invention is a transceiver unit and a transceiver system for controlling photographic equipment comprised of at least two separate transceiver units. Each transceiver unit of the present invention can be pre-set as an “originating,” “remote” or “relay” unit, and regardless of which setting, each unit is capable of transmitting and receiving coded signals, hence they are transceivers. Each transceiver unit has at least one selector switch, input and output connections, a radio transceiver chip, a microcontroller and associated electronic circuits. Encoded sequenced pulses containing control codes are transmitted, received and/or relayed between transceiver units. The ability to select the primary function of any one transceiver unit of the present invention allows identical transceiver units to be flexibly employed and readily configured by the user.

### BRIEF DESCRIPTION OF THE DRAWINGS

FIG. 1 is a circuit block diagram of the present invention.

FIG. 2 is a frequency and signal path block diagram of the present invention.

FIG. 3 shows two transceiver units of the present invention as used with a camera and a remote flash.

FIG. 4 shows two transceiver units of the present invention as used with a camera and a remote flash, with a third transceiver unit operating as an intermediate relay.

FIG. 5 shows three transceiver units of the present invention as used with a remote camera and a remote flash.

FIG. 6 shows two transceiver units of the present invention as used with a camera, a dedicated adapter and a remote flash.

### DETAILED DESCRIPTION

The present invention is a transceiver unit 100, as well as system comprised of two or more transceiver units 100. Each transceiver unit 100 in the system is functionally identical and can be configured to interact with one or more other transceiver units as desired by the user.

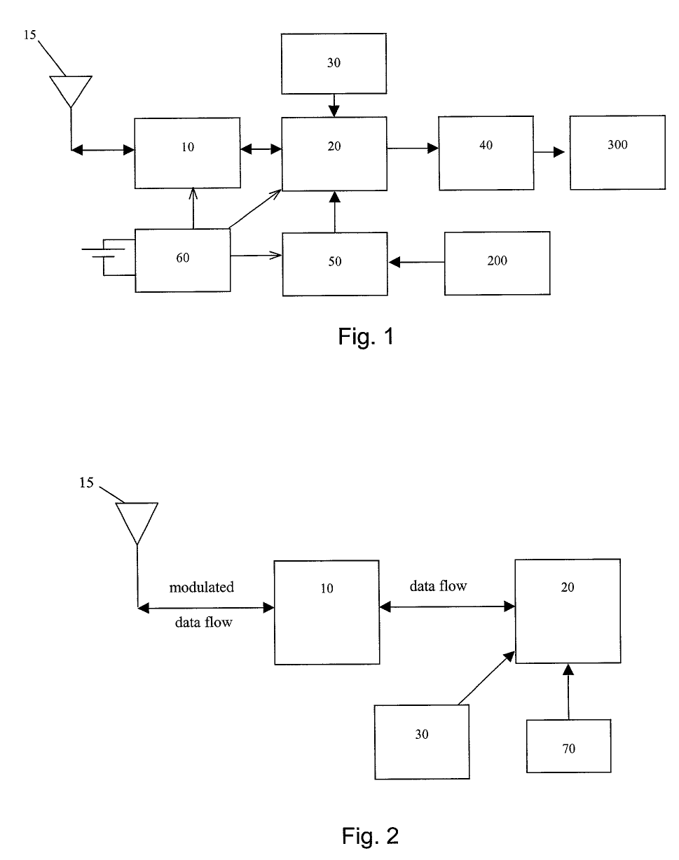

For radio frequency signal transmissions, the transceiver unit 100 has an antenna 15, a transceiver circuit 10, power supply 60, microcontroller 20, timing circuit 70, driver circuit 40, trigger circuit 50 and at least one selector switch 30. FIG. 1 depicts the block diagram for a transceiver unit 100 of the present invention. As is common practice in radio frequency art, an antenna 15 is connected to a radio frequency transceiver chip or hybrid circuit. The radio frequency transceiver chip or hybrid circuit is of a type that is commercially available and is known to those skilled in the art. If the signal transmission is via visible or invisible light pulses, then the antenna 15 would be replaced by a light sensor such as a photodiode and a light emitter, such as an infrared light emitting diode, coupled to a commercially available transceiver chip made specifically for communication via light pulses.

The transceiver chip communicates with a commercially available microcontroller 20 from which the transceiver chip receives commands and codes and to which it sends coded information. The selector switches 30 connected to the microcontroller 20 set the operating modes for the transceiver unit 100. As is typical in the art, a DC-to-DC converter converts battery voltage to the necessary operating voltage required by the circuits.

The transceiver unit 100 of the invention includes trigger means allowing the unit to be externally triggered, such as by the flash synchronization signal from a camera 200 or by an external manual trigger, such as a user operated push button. The transceiver unit 100 also includes output driver means for triggering flash units or camera motor drives. Such trigger means and output driver means are of a type known in the art.

The system of the present invention may be configured in any number of ways, including but not limited to, a two unit system with a local transmitting unit and a remote receiving unit, a multi-unit relay system, or a single transmitting unit with multiple remote receiving units. The activation of the transmitting unit can be initiated manually or synchronized with a flash signal or a camera shutter signal.

Operation of the system of the present invention involves at least two transceiver units. At least one such unit will be set to “transmit” by position of the selector switches 30, and the microcontroller 20 will command the transceiver unit 100 to operate in a transmit mode. The unit so set will then wait for a trigger signal, either generated by an external signal or via a push button manually operated on the transceiver unit 100 itself. Upon activation by a trigger, the microcontroller 20 will send a coded signal to the transceiver circuit 10, which will in turn generate a modulated radio frequency (RF) signal to be transmitted by the antenna 15. The coding of the transmitted signal may be through an encoding algorithm such as Manchester encoding, which produces a “balanced” code that allows for better noise rejection in receivers. The modulation method may be of any type as is commonly employed for control devices like the present invention, such as ASK (amplitude shift keying), FM (frequency modulation), FSK (frequency shift keying), OOK (on off keying) and others.

While the transceiver unit 100 may operate with one selector switch 30, preferably more than one selector switch 30 will be used to allow for a more diverse instruction set.

FIG. 2 depicts the signal flow between the various elements of the transceiver unit 100.

A second remote transceiver unit 100 typically would be set by one of its selector switches 30 to “receive.” The modulated RF signal picked up by the antenna 15 is fed to the ‘receiving’ transceiver unit 100, demodulated, and sent to the microcontroller 20 of the receiving unit. The microcontroller 20 decodes the signal and decides if the signal is valid. If the signal is valid, the driver circuit 40 of the receiving unit activates a camera 200 or flash unit which may be connected to it, as the case may be.

The activation of the receiving unit depends on the settings of selector switches 30. The present invention allows a user to activate transceiver units independently of other transceiver units on separate channels or to activate a plurality of transceiver units together on the same channel. The selector switches 30 allow a user to determine desired channel and zone setting for the transceiver unit, as well as specialized functions for the remote electronic device. The transceiver units of the invention may also send identification codes as part of the transmitted signal to allow discrimination between different systems operated by different users operating in the area, to prevent interference. As is common practice with control devices, a series of switches can be set to achieve a desired inter-unit compatibility or discrimination. The invention allows transceiver units on the same channel to be controlled separately in different zones as a means of quickly changing combinations of transceiver unit activation.

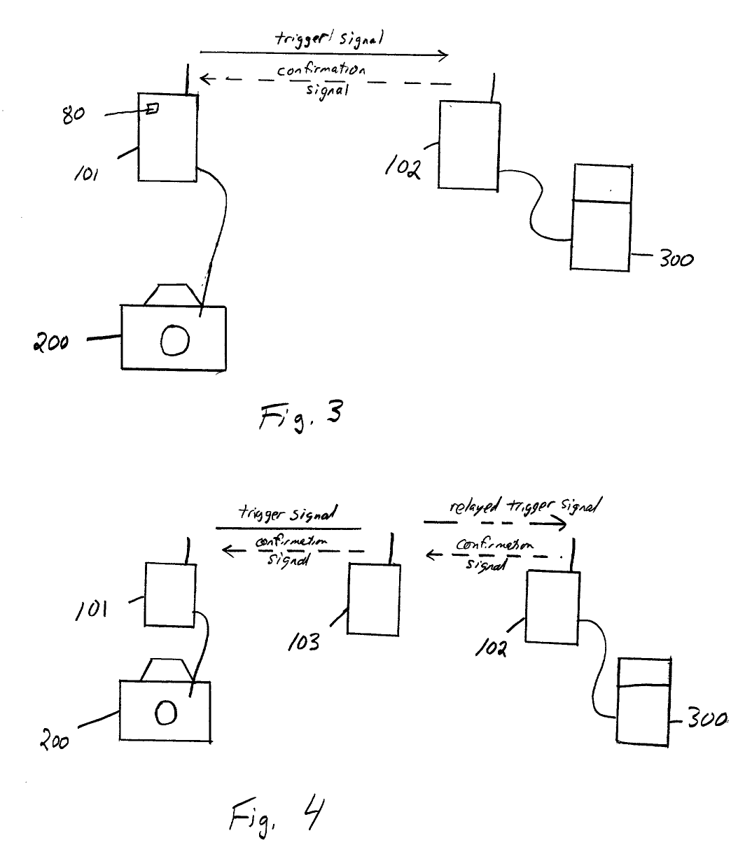

A key feature of the invention is the transmission of a confirmation signal, indicating receipt of the original transmission signal or message by receiver. This confirmation signal is sent by the receiving unit back to the transmitting unit, as is shown in FIG. 3. The confirmation signal is made possible through the use of the transceiver chip as part of the units. When a receiving unit 102 detects and decodes a valid command, the microcontroller 20 of the receiving unit 102 switches the transceiver chip from receive mode to transmit mode, and a confirmation code is then transmitted. Meanwhile, the transmitting unit 101, after sending the originating signal, is switched by its microcontroller 20 to a receive mode. The timing of the microcontroller's commands is set so that the transmitting unit 101 receives and decodes the confirmation signal, and indicates confirmation to the operator, via visual or audible means 80.

This confirmation signal is useful in various ways. With prior art systems, a photographer at a distance from the equipment being controlled remotely may not know whether the remote receiving unit has received the signal from the transmitting unit. A remote camera or flash may not activate, requiring the photographer to troubleshoot the cause of the failure. The cause for the failure of the remote camera or flash may be related to a malfunction of the camera or flash, the wire between the camera or flash and receiving unit, incorrect coding, or a problem or interference with the radio signal between the transmitter and the receiver. The return confirmation signal of the present invention provides the user valuable troubleshooting information and increased confidence in his equipment setup by informing the user whether the transmitting unit and the receiving unit have communicated as desired.

The transceiver units of the present invention may also function in a relay fashion, implemented by using three or more transceivers as depicted in FIG. 4. The first transceiver unit 101 is set to transmit, the last transceiver unit 102 to receive, and any intermediate transceiver units 103 are set to “relay” mode. The transceiver units are spread out so as to cover the distance required by the user, which would be a greater distance than the range of any pair of transceiver units. The transmitted signal is received by the first relay unit 103, which then retransmits it on the instruction of the microcontroller 20. This relayed signal is received by the next unit, and if it is a relay unit 103, the signal is retransmitted. Each unit in the relay chain would have previously been preset by switches to decode and encode the signal it receives. The final destination of the signal is the receiving unit 102, which decodes and triggers the particular equipment attached thereto.

Preferably, each relay unit 103 will modify the encoding of the transmitted signal from the signal as received, to ensure the proper sequential operation of the relay chain and avoid duplicate signal transmissions or receipts. The order of the relay units 103 may be predetermined and set with the selector switches 30.

The operation of the system in various configurations is set forth below.

Remote Trigger and Confirmation

In this configuration, as shown in FIG. 3, a photographer may wish to trigger one or more remote flash units 300 or cameras 200. One transceiver unit 100 is pre-set as an originating unit 101 which sends an encoded signal to a remote transceiver unit or units 102 pre-set as remote receiver(s). The remote transceiver units 102 receive the radio signal and decode the channel, zone and command code. If the channel and zone code received match the settings on the remote transceiver unit 102, in accordance with the selector switches 30, then the microcontroller 20 of the remote transceiver unit 102 determines that the commands which follow are valid and they are carried out.

The initial command would be to trigger a flash 300 or camera 200 connected to the remote transceiver unit 102. Furthermore, upon receiving valid system and channel codes, the remote transceiver unit 102 switches to transmit mode and sends a confirmation command back to the originating transceiver unit 101. The originating transceiver unit 101, meanwhile, has switched to receive mode and is able to decode the confirmation signal sent by the remote transceiver unit(s) 102. The originating transceiver unit 101 then indicates by visual or audible means 80 that the transmission was successfully completed.

Relay Trigger and Confirmation

The range that remote controls may operate over is limited by various factors. A way to improve on the maximum range is provided for by the present invention.

Originating and remote transceiver units 101 and 102 are set up as described before, configured as shown in FIG. 4. It is assumed that the distance between these two units is too great to allow communication. In between the originating and remote transceiver units are placed one or more transceiver units 103 set to “relay” mode.

When an originating transceiver unit 101 sends system, channel, and command signals, the first relay transceiver unit 103 receives the signal. The relay transceiver unit 103 immediately switches to transmit mode and retransmits the original signal to the next relay transceiver unit 103, or to the final remote transceiver unit 102, as the case may be. The final remote transceiver unit 102 receives the signal and carries out the command of the originating transceiver unit 101. Each relay transceiver unit 103 modifies the coded signal to avoid interfering with other signals along the relay chain. Preferably, the modification to the coded signal is done by changing the system code.

Remote Camera/Remote Flash

Another application for the present invention is to trigger a remote camera 200, which then wirelessly synchronizes a remote flash 300.

As shown in FIG. 5, the originating transceiver unit 101 sends a coded signal to a relay transceiver unit 103 which activates the camera shutter. Though activated, the actual release of the shutter is delayed by the camera mechanism. The remote flash 300 must fire exactly when the shutter opens, at the instant the camera 200 generates the flash sync signal, which occurs some variable time after the initial radio signal. Therefore, a second radio signal is sent by the relay transceiver unit 103 which is received by a third remote transceiver unit 102 for the flash synchronization. In the process the relay transceiver unit 103 switches from receive to transmit mode, and also slightly changes the code, such as to a different system, in order not to interfere with other radio commands, such as those commands transmitted by the originating transceiver unit 101.

The remote transceiver unit 102 may then send a confirmation signal back to the relay transceiver unit 103, which in turn sends confirmation back to the originating transceiver unit 101.

This application of the invention devices requires three transceiver units: one set to originate 101, one set to relay 103, and one set to remote 102. Implementing this operation with existing devices requires four separate devices set up as two transmitters and two receivers.

Radio Control of TTL

TTL is “through the lens” exposure control by a camera. TTL exposure control is considered more accurate than some other methods. When TTL controls a flash the camera sends a start and stop command to the flash via signal contacts between the flash and camera.

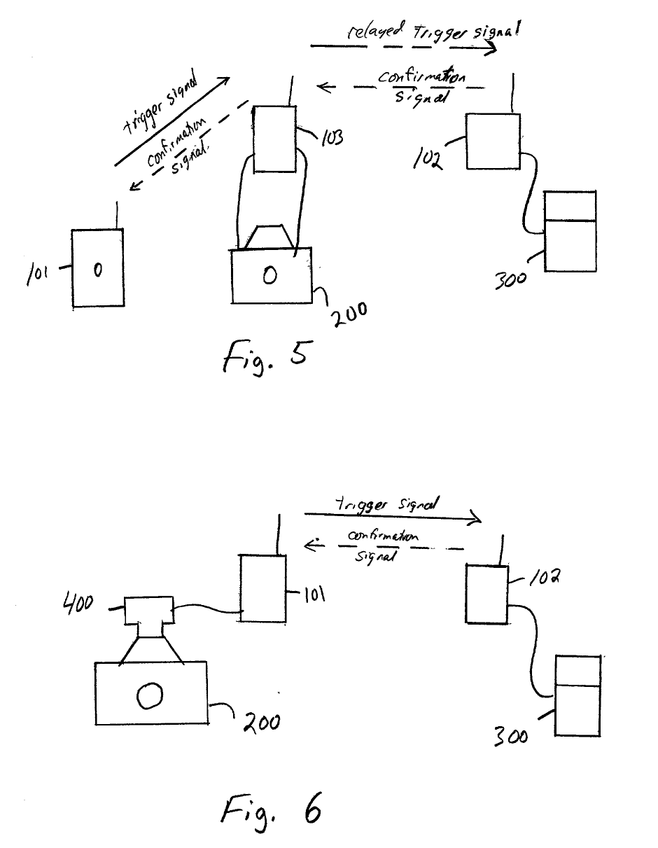

As shown in FIG. 6, an originating transceiver unit 101 of the present invention encodes the start and stop commands from the camera 200 and sends them via transmitted signal to a remote transceiver unit 102 connected to a flash 300. Flash exposure control is then achieved wirelessly. Furthermore, radio confirmation of the TTL signal is sent back to the originating transceiver unit 101.

To implement wireless TTL (through the lens) exposure control by the camera 200 of remote flashes 300 the operator of the present invention sets the operating mode of the transmitting transceiver unit 101 to TTL control with the selector switches 30. The transceiver unit 101 is set to transmit and, when commanded by a camera 200, sends a coded signal to a receiving transceiver unit 102. The receiving transceiver unit 102 decodes the signal and triggers the flash 300 connected to it. The transmitting transceiver unit 101 meanwhile continues to send data, such as a string of digital 1's (or 0's), for the time the camera 200 commands the flash 300 to continue firing. The receiving transceiver unit 102 continues firing the flash 300 for the time commanded by the camera 200, and then shuts off the flash 300.

Radio Control of Dedicated Adapters

A dedicated adapter between a flash and camera provides two-way communication of photographic parameters, such as f-number, shutter speed, start and stop commands, film speed, etc. Normally, dedicated adapters are incorporated within flash units, or implemented as wired devices between flashes and cameras.

Prior art for remote flash communication has involved one-way communication from camera to flash utilizing transmitters and receivers. However, the present invention utilizes transceivers to implement two-way communication between a camera 200 and flash 300 to achieve full functionality of the so-called dedicated adapter function.

As shown in FIG. 6, an originating transceiver unit 101 of the present invention encodes the photographic data of dedicated adapter 400 and transmits this data to remote transceiver unit 102.

Radio Control for Two Stage Camera Control

Most modem cameras require two switch closures to take a picture. The first switch closure turns on the auto-focus and light metering circuits. After a period of stabilization, a second switch closure releases the shutter. A period of delay usually occurs after the first switch closure until the camera circuits stabilize and allow the shutter to release.

The present invention accomplishes two-stage remote shutter release of cameras. An originating transceiver unit 101 sends a shutter release command which is received by a remote transceiver unit 102. The remote transceiver unit 102 generates a first switch closure, and after a delay a second switch closure. This operation allows a photographer to mimic the shutter button of a camera by activating only the focus and metering circuits (with a quick push of a button on the originating transceiver unit 101), or by holding the button to activate the camera and release the shutter, or by a quick push to activate the camera and then a second push of the button to release the shutter at the desired moment.

Wireless Control of Cycling or Sequencing Remote Equipment

Certain electronic devices incorporate capacitors which require recharging between uses or otherwise cannot be activated continuously. For example, when triggering photographic flash apparatus there is a waiting period between triggers necessary to allow the flash capacitors to recharge. Other equipment capable of being operated remotely by the present invention may also require a waiting period between activation, thereby limiting the rate of activation. Prior art remote activation devices do not adapt for such waiting periods.

The present invention allows for such waiting periods and alleviates the problem by providing sequential triggering of transceiver units 100 connected to multiple remote flash devices, cameras, or similar equipment. During such repetitive activation, each remote device may be activated in sequence, thereby reducing the overall duration between activation. Originating transceiver unit 101 sends a series of triggering signals to receiving transceiver units 102. Each receiving transceiver unit 102 is set to activate on one of the triggering signals, by setting an appropriate channel or zone code. The series of triggering signals transmitted by the originating transceiver unit 101 includes specific channel and zone codes to activate the individual receiving transceiver units 102 in the desired order.

The preferred embodiment of the present invention preferably will include additional features for ease of use in the photographic industry.

The so-called “hot shoe” of a camera is a convenient mounting for flash units and other camera accessories, including the present invention and similar devices. Sometimes hot shoe mounting is advantageous and sometimes disadvantageous, depending on the needs and set ups photographers choose.

The transceiver unit 100 of the present invention may employ a removable hot shoe mount. This hot shoe mount has all the necessary connections between the transceiver unit 100 and the camera 200, and can be removed when not needed or desired. Alternate means of connecting signals between the transceiver units and camera 200 and flash 300 equipment are provided.

Remote control devices used in photography are most often battery powered. Means to preserve battery power are improved by the present invention.

In order to conserve power and prolong battery life, the transceiver units of the present invention may enter a sleep or hibernation mode during periods of inactivity. The period of inactivity which activates the sleep mode may be set to any useful duration, such as 15 or 30 minutes. Battery power will be conserved during this period. However, the transceiver units can be switched to full function mode either remotely or directly. Pressing a button on a transceiver unit 100 for several seconds, or switching the transceiver unit 100 off and on again, will take the unit out of hibernation mode. Remote and relay transceiver units will wake up after they receive valid system and channel codes.

During the sleep mode, the microcontroller 20 “wakes up” periodically, turns on the transceiver chip, and checks for signals. If a valid coded signal is detected, the microcontroller 20 activates the entire transceiver unit 100 out of sleep mode. By setting the wake up time to be very short (several milliseconds) and the sleep time in between waking intervals to be long (several seconds), significant power can be conserved, as only essential circuits need be powered during sleep. Furthermore, this feature allows a user to wake up a remote relay or receiver transceiver unit 100 by transmitting to it steadily for a period, a few seconds for example, and during that time the remote transceiver unit 100 will have woken and checked for signals, and therefore wake itself out of sleep mode. The hibernation feature of these units may be disabled when desired.

While certain novel features of the present invention have been shown and described, it will be understood that various omissions, substitutions and changes in the forms and details of the device illustrated and in its operation can be made by those skilled in the art without departing from the spirit of the invention.

What is claimed is:

1. A transceiver unit for the remote control of an electronic device, the transceiver unit comprising:
a transceiver circuit, capable of receiving and decoding a first transmitted signal and capable of encoding and transmitting a second transmitted signal;
a microcontroller connected to the transceiver circuit, where the microcontroller may function in a plurality of operating modes and where the microcontroller is capable of processing the first and second transmitted signals in accordance with one of the plurality of operating modes;
at least one selector switch connected to the microcontroller, where the selector switch is capable of directing the microcontroller to function in one of the plurality of operating modes;
an external triggering means connected to the microcontroller, the external triggering means capable of providing a trigger signal to the microcontroller;
output driving means connected to the microcontroller, the output driving means capable of providing control instructions to the electronic device; and
means for connecting the transceiver unit to an external power supply,
where the microcontroller is capable of sending operating and data signals to the transceiver circuit and the output driving means in accordance with the plurality of operating modes.

2. The transceiver unit of claim 1, where the first transmitted signal provides the microcontroller with instructions to direct the operations of one of the transceiver circuit and the output driving means.

3. The transceiver unit of claim 1, where the second transmitted signal comprises a confirmation code acknowledging receipt of the first transmitted signal.

4. The transceiver unit of claim 1 further comprising a timing circuit.

5. The transceiver unit of claim 1 further comprising a display indicator connected to the microcontroller for indicating the status of the transmission of one of the first and second transmitted signals.

6. The transceiver unit of claim 1 where the output driving means comprises an output connector that interfaces with the electronic device.

7. The transceiver unit of claim 1 where the trigger signal provided by the external triggering means comprises a signal generated by an external control device, which external trigger signal sets the microcontroller to operate in one of the plurality of operating modes.

8. The transceiver unit of claim 7 where the external control device is a camera.

9. The transceiver unit of claim 1 where the first and second transmitted signals are each comprised of a control signal and a data signal.

10. The transceiver unit of claim 9 where the control signal is further comprised of channel and zone information.

11. The transceiver unit of claim 1 where one of the plurality of operating modes comprises a hibernating or low-power mode, where the microcontroller periodically activates the transceiver circuit to detect if the first transmitted signal is being transmitted and if so, the microcontroller changes the operating mode from hibernation or low-power mode.

12. The transceiver unit of claim 1 where the first and second transmitted signals are radio frequency signals.

13. The transceiver unit of claim 1 where the first and second transmitted signals are optical signals.

14. A transceiver system for the remote control of an electronic device, the transceiver system comprising:
A first transceiver unit and a second transceiver unit, each transceiver unit further comprising
a transceiver circuit, capable of transmitting and receiving signals;
a microcontroller connected to the transceiver circuit, where the microcontroller may function in a plurality of operating modes and where the microcontroller is capable of decoding a received first signal and of encoding a second signal for transmittal, in accordance with one of the plurality of operating modes;
at least one selector switch connected to the microcontroller and capable of directing the microcontroller to function in one of the plurality of operating modes;
an external triggering means connected to the microcontroller, the external triggering means capable of providing a trigger signal to the microcontroller;
output driving means connected to the microcontroller, the output driving means capable of providing control instructions to the electronic device;
a display indicator connected to the microcontroller for indicating the status of the transmission of one of the first and second signals; and
means for connecting the transceiver unit to an external power supply,
where the microcontroller is capable of sending operating and data signals to the transceiver circuit and the output driving means,
where the first transceiver unit is capable of transmitting the first signal and of receiving the second signal and the second transceiver unit is capable of receiving the first signal and of transmitting the second signal, where the second signal is different from the first signal.

15. The transceiver system of claim 14 where the first and second signals are radio frequency signals.

16. The transceiver system of claim 14 where the first and second signals are optical signals.

17. The transceiver system of claim 14 further comprising
a third transceiver unit, where the third transceiver unit is capable of receiving the first signal and of transmitting a third signal, where the third signal is different from the first signal, and
where the first transceiver unit is capable of receiving the third signal.

18. The transceiver system of claim 14 further comprising
a third transceiver unit, where the third transceiver unit is capable of receiving a fourth signal and of transmitting a third signal, where the fourth signal is different from the first signal, and
where the first transceiver unit is capable of transmitting the fourth signal and is capable of receiving the third signal.

19. The transceiver system of claim 14 further comprising
a third transceiver unit, where the third transceiver unit is capable of receiving the second signal and of transmitting a third signal, where the third signal is different from the second signal, and
where the second transceiver unit is capable of receiving the third signal.

20. The transceiver system of claim 14 where the plurality of operating modes comprises a hibernating or low-power mode, where the microcontroller of one of the transceiver units periodically activates the transceiver circuit to detect if the first transmitted signal is being transmitted from the other transceiver unit and if so, the microcontroller changes the operating mode from hibernation or low-power mode.

21. A transceiver unit for the remote control of an electronic device, the transceiver unit comprising:
a transceiver circuit, capable of receiving and decoding a first transmitted signal and capable of encoding and transmitting a second transmitted signal;
a microcontroller connected to the transceiver circuit, where the microcontroller may function in a plurality of operating modes;
an operational selector switch connected to the microcontroller and capable of directing the microcontroller to function in one of the plurality of operating modes;
an external triggering means connected to the microcontroller, the external triggering means capable of providing a trigger signal to the microcontroller;
an output driving means connected to the microcontroller, the output driving means capable of providing control instructions to the electronic device;
an output connector which interfaces with the electronic device being controlled;
a display indicator connected to the microcontroller for indicating the status of the transmission of one of the first and second transmitted signals; and
means for connecting the transceiver unit to an external power supply, where the microcontroller is capable of sending operating and data signals to the transceiver circuit and the output driving means.
